(19) United States
(12) Patent Application Publication
(10) Pub. No.: US 2026/0356986 A1
(43) Pub. Date: Nov. 12, 2026

(54) INJECTION MOLDED ARTICLES AND METHODS OF MANUFACTURING THEREOF

(71) Applicant: Eastman Chemical Company, Kingsport, TN (US)

(72) Inventors: Hamid Ebrahimi, Kingsport, TN (US); Thomas Edward Carter, Kingsport, TN (US); Michael Eugene Donelson, Kingsport, TN (US); Steven Thomas Perri, Kingsport, TN (US)

(73) Assignee: Eastman Chemical Company, Kingsport, TN (US)

(21) Appl. No.: 19/712,880

(22) Filed: Jun. 18, 2026

Related U.S. Application Data
(63) Continuation of application No. PCT/US2024/060455, filed on Dec. 17, 2024.
(60) Provisional application No. 63/611,328, filed on Dec. 18, 2023.

(51) Int. Cl. C08B 3/06; B29C 44/02; B29C 45/00; B29K 1/00; B29K 105/00; B29K 105/04; C08J 9/12

(52) U.S. Cl. CPC C08B 3/06; B29C 44/02; B29C 45/0001; C08J 9/12; B29K 2001/12; B29K 2105/0038; B29K 2105/04; C08J 2301/10

(57) ABSTRACT

A method of manufacturing an injection molded article, the method comprising: providing a flowable melt composition comprising a cellulose diacetate, a viscosity reducing additive, and a chemical blowing agent; introducing the flowable melt composition into a mold cavity of an injection molding machine; molding the flowable melt composition at a pressure P, a temperature T, and a cycle time C in the mold cavity to form the injection molded article having a length L and a density D in the range of 0.9 to 1.6 g/cc, wherein the method exhibits at least one of the following: a reduction in pressure P, a reduction in temperature T, a reduction in cycle time C, when compared to an injection molded article using a melt composition having the same formulation as the flowable melt composition but without the chemical blowing agent.

### TECHNICAL FIELD

Disclosed in embodiments herein are methods of manufacturing injection molded articles formed from a biodegradable and/or compostable cellulose ester formulations, and the injection molded articles.

### BACKGROUND

Many plastic articles, such as rigid cutlery and foamed food-packaging articles, are single-use items that are intended to be disposed of after use. However, many commonly-used plastics, such as polystyrene, are neither compostable nor biodegradable. Moreover, some municipalities, states, and countries have enacted, or are considering enacting, bans on the use of polystyrene-based materials. Thus, it is desirable to find alternative materials for use in plastic articles, as well as viable compositions, methods, and systems for producing such articles.

### SUMMARY

In some embodiments herein, there is provided a method of manufacturing an injection molded article, the method comprising: providing a flowable melt composition comprising a cellulose diacetate, a viscosity reducing additive, and a chemical blowing agent that is decomposable to form carbon dioxide, water, or nitrogen; introducing the flowable melt composition into a mold cavity of an injection molding machine; molding the flowable melt composition at a pressure P, a temperature T, and a cycle time C in the mold cavity to form the injection molded article having a length L and a density D in the range of 0.9 to 1.6 g/cc, wherein the pressure P is from 10,000 to 40,000 psi, the temperature T is from 400 to 560 degrees Fahrenheit, and the cycle time C is from 8 to 30 seconds; wherein the method exhibits at least one of the following: a reduction in pressure P by 5% to 40% when compared to an injection molding pressure P2 required to form an injection molded article using a melt composition having the same formulation as the flowable melt composition but without the chemical blowing agent; a reduction in temperature T by 1% to 15% when compared to an injection molding temperature T2 required to form an injection molded article using a melt composition having the same formulation as the flowable melt composition but without the chemical blowing agent; a reduction in cycle time C by 2% to 30% when compared to an injection molding cycle time C2 required to form an injection molded article using a melt composition having the same formulation as the flowable melt composition but without the chemical blowing agent.

In other embodiments herein, there is provided a method of manufacturing an injection molded article, the method comprising: providing a flowable melt composition comprising a cellulose diacetate, a viscosity reducing additive, and a physical blowing agent; introducing the flowable melt composition into a mold cavity of an injection molding machine; molding the flowable melt composition at a pressure P, a temperature T, and a cycle time C in the mold cavity to form the injection molded article having a length L and a density D in the range of 0.9 to 1.6 g/cc, wherein the pressure P is from 10,000 to 40,000 psi, the temperature T is from 400 to 560 degrees Fahrenheit, and the cycle time C is from 8 to 30 seconds; wherein the method exhibits at least one of the following: a reduction in pressure P by 5% to 40% when compared to an injection molding pressure P2 required to form an injection molded article using a melt composition having the same formulation as the flowable melt composition but without the physical blowing agent; a reduction in temperature T by 1% to 15% when compared to an injection molding temperature T2 required to form an injection molded article using a melt composition having the same formulation as the flowable melt composition but without the physical blowing agent; a reduction in cycle time C by 2% to 30% when compared to an injection molding cycle time C2 required to form an injection molded article using a melt composition having the same formulation as the flowable melt composition but without the physical blowing agent.

In further embodiments herein, there is provided an injection molded article, the article being formed from a flowable melt composition, the flowable melt composition comprising: a cellulose diacetate, a viscosity reducing additive, and a blowing agent, wherein the flowable melt composition is configured to be injected into a mold cavity of an injection molding machine, wherein when the flowable melt composition is injected into a mold cavity of an injection molding machine at a pressure P, a temperature T, and a cycle time C, the flowable melt composition forms the injection molded article having a length L and a density D in the range of 0.9 to 1.6 g/cc, wherein the pressure P is from 10,000 to 40,000 psi, the temperature T is from 400 to 560 degrees Fahrenheit, and the cycle time C is from 8 to 30 seconds; wherein the injection molded article exhibits a reduction in density D by 0.5% to 20% when compared to a density D2 of an injection molded article formed under the same conditions using a melt composition having the same formulation as the flowable melt composition but without the blowing agent.

In one or more embodiments herein, the chemical blowing agent is selected from the group consisting of sodium bicarbonate, monosodium citrate, zinc stearate, aliphatic polyester, poly(butylene succinate-co-butylene adipate), caprolactone and combinations thereof, and is present in an amount of 0.1 to 5.0 wt. % of the flowable melt composition.

In one or more embodiments herein, the physical blowing agent is selected from the group consisting of hydrocarbons, chlorofluorocarbons, nitrogen, carbon dioxide, alcohols, ketones, methyl esters, and combinations thereof, and is present in an amount of 0.1 to 5.0 wt. % of the flowable melt composition.

In one or more embodiments herein, the cellulose diacetate is present in an amount of 50 to 80 wt. % of the flowable melt composition.

In one or more embodiments herein, the cellulose diacetate exhibits one or more of the following properties: a degree of substitution of acetyl substituents (DSAC) per anhydroglucose unit (AGU) is 2.2 to 2.8; a metals-to-sulfur molar ratio (M/S) of from 1.35 to 5.0; or a number average molecular weight (Mn) of from 10,000 g/mol to 100,000 g/mol as according to ASTM D6474.

In one or more embodiments herein, the viscosity reducing additive is present in an amount of 2 to 40 wt. % of the flowable melt composition.

In one or more embodiments herein, the viscosity reducing additive is selected from the group consisting of glycerol triacetate (triacetin), glycerol diacetate, dibutyl terephthalate, dimethyl phthalate, diethyl phthalate, polyethylene glycol having a molecular weight of 200-600 g/mol, triethylene glycol dipropionate, 1,2-epoxypropylphenyl ethylene glycol, 1,2-epoxypropyl(m-cresyl)ethylene glycol, 1,2-epoxypropyl(o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, tripropionin, poloxamer copolymers, polyethylene glycol succinate, diisobutyl adipate, polyvinyl pyrollidone, and glycol tribenzoate, triethyl citrate, acetyl triethyl citrate, polyethylene glycol, poly (alkyl succinates) such as poly (butyl succinate), polyethersulfones, adipate based viscosity reducing additives, soybean oil epoxides, sucrose-based viscosity reducing additives, dibutyl sebacate, tributyrin, tripropionin, sucrose acetate isobutyrate, the Resolflex™ series of viscosity reducing additives, triphenyl phosphate, glycolates, methoxy polyethylene glycol, 2,2,4-trimethylpentane-1,3-diyl bis(2-methylpropanoate), and polycaprolactones, and combinations of two or more thereof.

In one or more embodiments herein, the flowable melt composition is biodegradable and/or compostable.

In one or more embodiments herein, the flowable melt composition further comprises an alkaline filler present in an amount of 0.1 to 20 wt. % of the flowable melt composition and/or a neutralizing agent, suitable for neutralizing the free alkali in the flowable melt composition, present in an amount of 0.1 to 5 wt. % of the flowable melt composition.

### BRIEF DESCRIPTION OF THE DRAWINGS

FIG. 1 is a schematic diagram illustrating another biodegradable article forming process according to embodiments of the present invention, particularly configured to form rigid articles;

FIG. 2 is a schematic diagram illustrating an extrusion section that may be used in the rigid article forming processes of FIG. 3, according to embodiments of the present invention; and

FIG. 3 is a graph illustrating injection molding flow lengths for various melt resins injected at various injection molding temperatures.

FIG. 4 is a pictorial illustration of the thermal degradation of molded parts when subjected to various injection molding temperatures.

### DETAILED DESCRIPTION

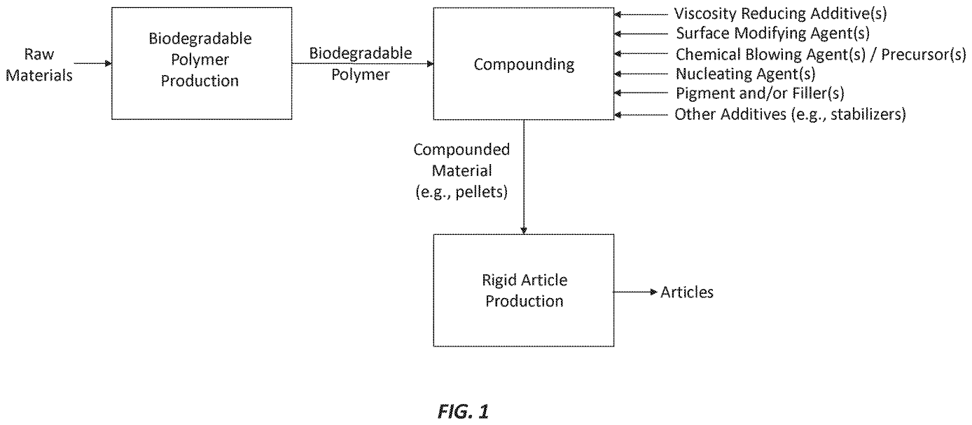

Embodiments are generally directed to methods, systems, and compositions for forming biodegradable particulate materials (e.g., pellets), and rigid articles. Exemplary processes including the methods, systems, and compositions are depicted in FIGS. 1-4 and are described in greater detail below. Rigid articles may include articles of various sizes and shapes, but, in some embodiments, include single-use cutlery, such as knives, spoons, forks, etc.

### Methods and Systems

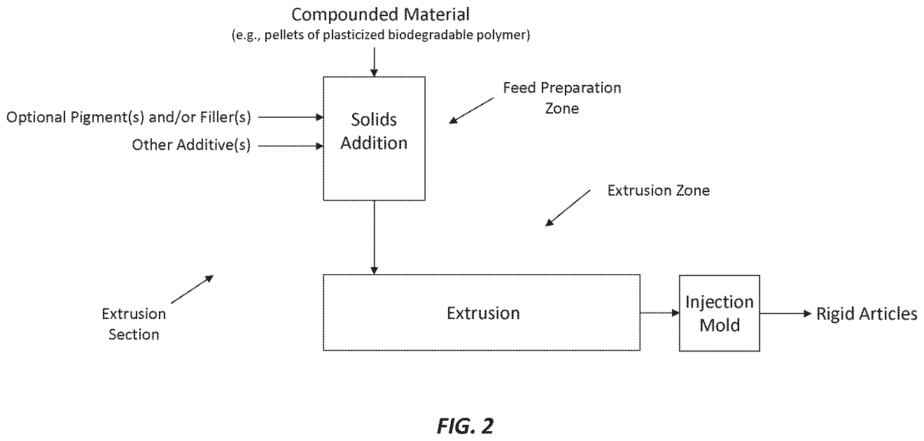

As shown in FIG. 1 and FIG. 2, raw materials may be introduced to a biodegradable polymer production process, which produces a biodegradable polymer material. In one embodiment or in combination with any other embodiment mentioned herein, the biodegradable polymer material comprises one or more cellulose esters. The one or more cellulose esters may comprise cellulose acetates. In such embodiments, the raw materials may comprise a pulp, such as wood pulp and/or cotton pulp. The pulp may be a dissolving-grade pulp and/or a paper-grade pulp. The cellulose in the pulp may esterified, for example with an acetic acid, to form the biodegradable cellulose ester polymer, such as a cellulose acetate polymer.

The biodegradable polymer material may then be introduced into a compounding process, in which the biodegradable polymer material may be mixed with a viscosity reducing additive, and optionally one or more other additives (e.g., stabilizers), and formed into a compounded material comprising viscosity reduced biodegradable polymer. Other additives may also be mixed with the polymer and viscosity reducing additive. For example, as shown in FIGS. 1 & 2, the other materials (additives) may include, but are not limited to, stabilizers, physical blowing agent(s), chemical blowing agent(s) (and/or precursors), nucleating agent(s), pigment(s), filler(s), and/or other additive(s). Mixing can be accomplished by any known mixing technique, including, but not limited to, rolling in a cylindrical container, overhead stirring, sigma blade mixing, and tumbling.

The compounding process may include a particulating process. The particulating process may generally comprise mixing the biodegradable polymer material, viscosity reducing additive, and other additive(s) to form a mixed composition and forming particulate material from the composition. In particular, the particulating process may include a pelletization process, and the particulate material may comprise a quantity of pellets. The term “compounded CE material” means cellulose ester material formed during the compounding process, which may include a mixture of cellulose ester, viscosity reducing additive, and other additives. Further such compounded CE material may be in the form of particulate material (e.g., pellets, powders, granules, fibers, etc.). It should be understood that, as used herein, the phrases “particulating” or “particulating processes” may be the same as, or may at least include, “pelletizing” or “pelletizing processes.” In some embodiments, the particulating process may include pelletizing into a water bath, pelletizing on an air cooled belt, underwater pelletizing, solvent compounding, etc.

In one embodiment or in combination with any other embodiment mentioned herein, the viscosity reducing additive and other additive(s) may be mixed with cellulose esters in the compounding process by conventional melt compounding techniques, which involve combining the cellulose ester with viscosity reducing additive, and optionally the other additives, in a twin screw extruder with appropriate mixing elements and at appropriate temperatures and pressures to achieve a molten, homogeneously combined, cellulose ester mixture by the time the materials exit the extruder. The molten, compounded, cellulose ester mixture may then be extruded through a die with orifices that are about 2-6 mm in diameter so as to extrude a strand. This strand may then be cooled by water (e.g., via underwater pelletization) or air and cut at regular intervals to provide a uniform and desirable size and shape, referred to as “pellets” or “granules.” Although a process for forming pelletized compounded material is described herein, it will be understood that the compounded material fed to the injection molding production process can be in any physical shape (e.g., pellets, powders, granules, fibers) in accordance with some embodiments.

The compounded CE material, which as noted above may comprise pellets of viscosity reduced biodegradable polymer, may then be introduced into a rigid article production process, as illustrated in FIGS. 1 and 2. The rigid article production zone may include one or more steps/zones to prepare rigid articles (e.g., single-use cutlery).

### Rigid Articles

Rigid articles may be formed from the flowable melt composition described herein using injection molding. Some cellulose-ester based polymers are difficult to injection mold due to poor flow characteristics of the polymers. Embodiment of the present invention have been found to achieve improved flow characteristics of the flowable melt composition used in the injection molding process, e.g., as illustrated in FIG. 2, through the addition of one or more blowing agents (BAs), such as chemical blowing agents (CBAs) or physical blowing agents (PBAs).

Such flowable melt compositions may have beneficial flow properties, which make them preferable for use in making rigid articles via injection molding. For example, a flowable melt composition comprising cellulose ester, a viscosity reducing additive, and BA may be injected, via an injection molding machine, into a mold under a reduced pressure than a pressure required to inject a basic melt composition comprising the same cellulose ester, and viscosity reducing additive, but with no BA. For example, a mold may present a cavity (e.g., a cavity with a width of 0.5 inches and a thickness of 0.3 inches). The flowable melt composition comprising cellulose ester, viscosity reducing additive, and BA may be injected, via the injection molding machine, into the mold at a first injection molding pressure P and at the injection molding temperature T, for a cycle time C, such that the flowable melt composition is formed into a first article having a length L and a density from 0.9 to 1.6 g/cc. Similarly, a basic melt composition comprising cellulose ester, viscosity reducing additive, and no BA may be injected, via the injection molding machine, into the mold at a second injection molding pressure P2 and at an injection molding temperature T2, for a cycle time C2, such that the melt composition is formed into a second article having a length L and a density from 0.9 to 1.6 g/cc. It is noted that the melt composition may be equivalent to the flowable melt composition with BA, except that the melt composition does not include BA.

Notably, injection molding pressure P required to injection the flowable melt composition with BA into the mold to form a given length L is from 5 to 40, from 10 to 35, from 20 to 30, and/or about 5-40% percent less than the injection molding pressure P2 required to inject the basic CBA melt resin without BA into the mold to form the given length L. For example, if a standard injection molding pressure need to inject the melt composition without BA (i.e., P2) is from 17,000 to 67,000 psi, then the reduced injection molding pressure P necessary to inject the flowable melt composition with BA may be from 10,000 to 40,000 psi. Without being bound by theory, it is believed that such a reduction in necessary pressure may be due to the use of BA, which appears to increase the flowability of the flowable melt composition by at least partially and/or temporarily foaming the resin.

Such flowability enhancement may also be beneficial to reduce the temperature required during injection molding. For example, the flowable melt composition comprising cellulose ester, viscosity reducing additive, and BA may be injected, via the injection molding machine, into the mold at a first injection molding temperature T and at an injection molding pressure P, for a cycle time C, such that the flowable melt composition is formed into a first article having a length L and a density from 0.9 to 1.6 g/cc. Similarly, a melt composition comprising cellulose ester, viscosity reducing additive, and no BA may be injected, via the injection molding machine, into the mold at a second injection molding temperature T2 and at the injection molding pressure P2, such that the melt composition is formed into a second article having a length L and a density from 0.9 to 1.6 g/cc.

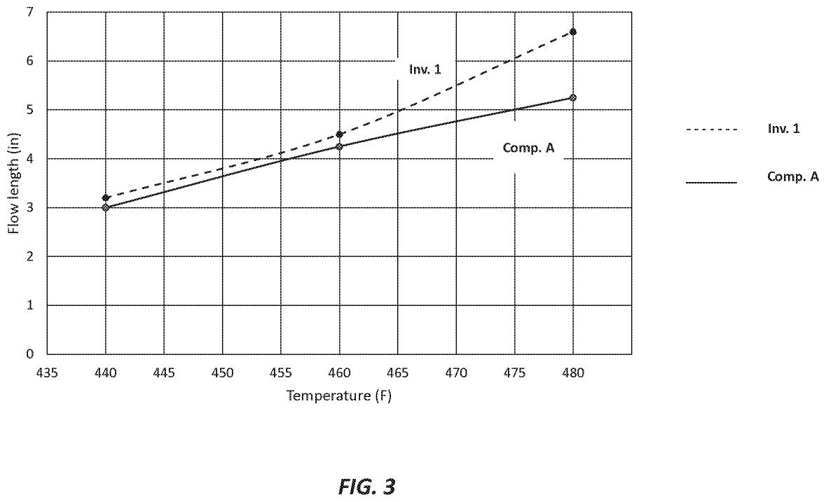

Notably, injection molding temperature T required to injection the flowable melt composition with BA into the mold to form a given length L is from 1% to 15%, from 2% to 8%, from 3% to 6%, and/or about 5 percent less than the injection molding temperature T2 required to inject the basic BA melt resin without BA into the mold to the given length L. For example, if a standard injection molding temperature need to inject the melt composition without BA (i.e., T2) is from 470 to 660 degrees Fahrenheit, then the reduced injection molding temperature T necessary to inject the flowable melt composition with BA may be from 5 to 100 degrees less than T2. FIG. 3 illustrates such beneficial flow characteristics of a flowable melt composition having BA (i.e., a CBA) with respect to a melt composition not having BA. The graph plots flow lengths (y-axis) of melt resins being injected, via an injection molding machine, into a mold at various temperatures (x-axis). The Comp. A resin comprises a melt composition without BA, whereas the Inv. 1 resin comprises the same melt composition as Comp. A except it further includes 2 wt. % of BA. As shown in FIG. 3, for each injection molding temperature value between 440 and 480 degrees Fahrenheit, the flowable melt composition with BA (i.e., Inv. 1) has a longer flow length than the melt composition without BA (i.e., Comp. A). Correspondingly, a given flow length can be achieved at a lower injection molding temperature.

Without being bound by theory, it is also believed that the use of BAs in the flowable melt composition may help increase the density and/or reduce shrinkage of rigid articles injection molded from the flowable melt composition. For example, a flowable melt composition comprising cellulose ester, viscosity reducing additive, and BA may be injected, via an injection molding machine, into a mold having a mold cavity (e.g., a cavity with a length of 5 inches, a width of 0.5 inches and a thickness of 0.3 inches). When the flowable melt composition comprising cellulose ester, viscosity reducing additive, and BA is injected into the mold to complete fill the mold cavity, the flowable melt composition will form a first article having a density D that is from 0.9 g/cm³ to 1.60 g/cm³ and a length L. In contrast, when the melt composition comprising cellulose ester, viscosity reducing additive, and no BA is injected into the mold to complete fill the mold cavity, the flowable melt composition will form a second article having a density D2 and a length L2. Notably the density D of the first article is from 0.5 to 20 percent less than the density D2 of the second article. In some specific embodiments, the density D of the first article is from 1% to 15%, from 2% to 10%, from 3% to 7%, from 4% to 6%, and/or about 5 percent less than the density D2 of the second article. In addition, the length L of the first article may be from 0.01 to 0.08 percent greater than the length L2 of the second article. In some specific embodiments, the length L of the first article is from 0.02 to 0.04 percent and/or about 0.03 percent greater than the length L2 of the second article.

Such an increase in density and/or a reduction in shrinkage (as indicated by the increased length) with respect to flowable melt compositions with BA versus melt compositions without BA can beneficially reduce the cycle time necessary to manufacture rigid articles from the flowable melt compositions via injection molding. As is commonly known, cycle time is the amount of time required to (1) inject a resin into a mold, (2) allow the resin to cool inside the mold to form the article, (3) open the mold to eject the article, and (4) reset the mold for the next cycle. It is generally understood that the second step, which is directed to cooling the resin within the mold is the most time intensive. Beneficially, it has been found that because the flowable melt composition with BA has an increase in density and/or a reduction in shrinkage over melt compositions without BA, the flowable melt composition with BA will provide more contact with the interior surfaces of the mold, which enhances the cooling of the flowable melt composition, thus, reducing the cooling time needed during each injection molding cycle. In some embodiments herein, the process exhibits a reduction in cycle time C by 2% to 30% when compared to an injection molding cycle time C2 required to form an injection molded article using a melt composition having the same formulation as the flowable melt composition but without the chemical blowing agent. All individual values and subranges are disclosed and included herein. For example, in some embodiments, the process exhibits a reduction in cycle time C ranging from a lower limit of 2%, 3%, 5%, 7%, or 10% to an upper limit of 30%, 28%, 25%, 23%, 20%, or 18% when compared to an injection molding cycle time C2 required to form an injection molded article using a melt composition having the same formulation as the flowable melt composition but without the chemical blowing agent.

In more detail, a flowable melt composition comprising cellulose ester, viscosity reducing additive, and BA may be injected, via an injection molding machine using a cycle time of C, to form a first article having a length of, for example, 5 inches, a width of, for example, 0.5 inches and a thickness of, for example, 0.3 inches. Similarly, a melt composition comprising cellulose ester, viscosity reducing additive, and no BA may be injected, via an injection molding machine using a cycle time of C2, to form a second article having a length of 5 inches, a width of 0.5 inches and a thickness of 0.3 inches. As an example, if the cycle time C2 necessary to injection mold an article from a melt composition with no BA is from 12 to 42 second (or from 12 to 15 seconds), the cycle time C necessary to injection mold an article from a flowable melt composition with BA may be as little as from 0.2 to 13 seconds.

### Flowable Melt Compositions

The processes described above may comprise the preparation and extrusion of flowable melt compositions that may be used for downstream processing to form useful articles. For example, in one embodiment or in combination with any other embodiment mentioned herein, the extrusion feed material may comprise a particulate material comprising a biodegradable polymer, a viscosity reducing additive, a blowing agent, and optionally one or more additive(s), such as those described herein. In one embodiment or in combination with any other embodiment mentioned herein, the feed material may be combined with one or more additive(s), such as those described herein, to provide a mixed composition comprising the biodegradable polymer, the viscosity reducing additive, and the one or more additive(s). In one embodiment or in combination with any other embodiment mentioned herein, the biodegradable polymer comprises cellulose ester. Additional details of the composition components, including biodegradable polymers (e.g., cellulose esters), viscosity reducing additives, and other additives, are provided below.

### Cellulose Ester

The cellulose esters utilized as described herein can be any that is known in the art. Cellulose ester that can be used for embodiments herein generally comprise repeating units of the structure:

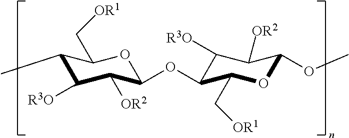

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In one embodiment or in combination with any other embodiment, n is an integer in a range from 25 to 250, or 25 to 200, or 25 to 150, or 25 to 100, or 25 to 75.

In one embodiment or in combination with any other embodiment, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In one embodiment or in combination with any other embodiment, cellulose esters can have an inherent viscosity (IV) of about 0.2 to about 3.0 deciliters/gram, or about 0.5 to about 1.8, or about 1 to about 1.5, as measured at a temperature of 25 °C for a 0.25 gram sample in 100 ml of a 60/40 by weight solution of phenol/tetrachloroethane. In one embodiment or in combination with any other embodiment, cellulose esters useful herein can have a DS/AGU of about 1 to about 3.0, of about 2.2 to about 2.8, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as acetic acid, acetic anhydride, and acid catalyst, or alternatively, LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In one embodiment or in combination with any other embodiment, the flowable melt composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A. Thus, cellulose esters used in embodiments of the present invention may include cellulose acetate (“CA”), cellulose acetate propionate (“CAP”), cellulose acetate butyrate (“CAB”), or combinations thereof. Such mixed cellulose esters may comprise various acetyl, propyl, and butyryl ratios; types; viscosities; and hydroxyl contents.

In one embodiment or in combination with any other embodiment, the cellulose ester can be prepared by converting cellulose to a cellulose ester with reactants that are obtained from recycled materials, e.g., a recycled plastic content syngas source. In one embodiment or in combination with any other embodiment, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a flowable melt composition comprising at least one recycle cellulose ester is provided, wherein the cellulose ester has at least one substituent on an anhydroglucose unit (AU) derived from recycled content material, e.g., recycled plastic content syngas.

In one embodiment or in combination with any other embodiment, the flowable melt composition comprises cellulose ester in an amount from 50 to 99 wt. %, or 60 to 99 wt. %, or 70 to 99 wt. %, or 80 to 99 wt. %, or 90 to 99 wt. %, 50 to 90 wt. %, or 60 to 90 wt. %, or 70 to 90 wt. %, or 80 to 90 wt. %, or 90 to 99 wt. %, or 50 to 80 wt. %, or 60 to 80 wt. %, or 70 to 80 wt. %, or 50 to 70 wt. %, or 60 to 70 wt. %, or 50 to 60 wt. %, all based on the total weight of the flowable melt composition. In some embodiments, the cellulose ester used herein may comprise a combination, blend, or mixture of two or more different types of cellulose esters. For example, in some embodiments, the cellulose esters used herein may be comprised of a blend of two or cellulose esters having differing DSACs; however, the blend may have an total DSAC of between 2.2 and 2.8.

In some embodiments, the cellulose esters used herein having a preferential metals-to-sulfur molar ratio (M/S). For example, the cellulose ester (forming the virgin or recycled cellulose ester polymers) may have a metals-to-sulfur molar ratio (M/S) of at least 1.35, or 1.35 to 10.0, or 1.35 to 8.0, or 1.35 to 6.0, or 1.35 to 5.0, or 1.4 to 10.0, or 1.4 to 8.0, or 1.4 to 6.0, or 1.4 to 5.0, or 1.45 to 10.0, or 1.45 to 8.0, or 1.45 to 6.0, or 1.45 to 5.0, or 1.5 to 10.0, or 1.5 to 8.0, or 1.5 to 6.0, or 1.5 to 5.0, wherein Mis the molar sum of metals selected from the group consisting of calcium, magnesium, potassium, sodium and combinations thereof and S is moles of sulfur. It has been found that materials formed from such cellulose esters can generate resins and resulting articles with reduced polymer degradation. As such, the cellulose ester used herein, such as in the various cellulose ester feedstocks, may include at least some recycled cellulose ester material.

### Viscosity Reducing Additives

In one embodiment or in combination with any other embodiment, the flowable melt compositions described herein can comprise at least one viscosity reducing additive. The viscosity reducing additive reduces the melt temperature, i.e., the Tg, and/or the melt viscosity of the cellulose ester. Viscosity reducing additives for cellulose esters may include glycerol triacetate (Triacetin), glycerol diacetate (Diacetin), dibutyl terephthalate, dimethyl phthalate, diethyl phthalate, poly(ethylene glycol) MW 200-600 (e.g., PEG400 or polyethylene glycol 400), dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl(m-cresyl)ethylene glycol, 1,2-epoxypropyl(o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing viscosity reducing additives such as the Benzoflex™ series, poly (alkyl succinates) such as poly (butyl succinate), polyethersulfones, o-Cresyl p-toluenesulfonate, n-ethyltoluenesulfonamides, adipate based viscosity reducing additives, soybean oil epoxides such as the Paraplex™ series, sucrose based viscosity reducing additives, dibutyl sebacate, tributyrin, sucrose acetate isobutyrate, the Resolflex™ series, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), and polycaprolactones. In some embodiments, the viscosity reducing additive used herein may comprise a combination or mixture of two or more different types of viscosity reducing additives.

In one embodiment or in combination with any other embodiment, the viscosity reducing additive is food-compliant. By food-compliant is meant compliant with applicable food additive and/or food contact regulations where the viscosity reducing additive is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant viscosity reducing additive is triacetin or polyethylene glycol (PEG) having a molecular weight of about 200 to about 600. In one embodiment or in combination with any other embodiment, examples of food-compliant viscosity reducing additives that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the viscosity reducing additive can be present in an amount sufficient to permit the flowable melt composition to be melt processed (or thermally formed) into useful articles, e.g., single use plastic articles, in conventional melt processing equipment. In one embodiment or in combination with any other embodiment, the viscosity reducing additive is present in an amount from 1 to 40 wt. % for most thermoplastics processing; or 5 to 25 wt. %, or 10 to 25 wt. %, or 12 to 20 wt. % based on the weight of the flowable melt composition. In one embodiment or in combination with any other embodiment, profile extrusion, sheet extrusion, thermoforming, and injection molding can be accomplished with viscosity reducing additive levels in the 10-30, or 12-25, or 15-20, or 10-25 wt. % range, based on the weight of the flowable melt composition.

In one embodiment or in combination with any other embodiment, the viscosity reducing additive is a biodegradable viscosity reducing additive. Some examples of biodegradable viscosity reducing additives include triacetin, triethyl citrate, acetyl triethyl citrate, polyethylene glycol, the benzoate containing viscosity reducing additives such as the Benzoflex™ series, poly (alkyl succinates) such as poly (butyl succinate), polyethersulfones, adipate based viscosity reducing additives, soybean oil epoxides such as the Paraplex™ series, sucrose based viscosity reducing additives, dibutyl sebacate, tributyrin, the Resoflex™ series, triphenyl phosphate, glycolates, polyethylene glycol, 2,2,4-trimethylpentane-1,3-diyl bis(2-methylpropanoate), and polycaprolactones.

In one embodiment or in combination with any other embodiment, the flowable melt composition can contain a viscosity reducing additive selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the flowable melt composition comprises at least one viscosity reducing additive (as described herein) in an amount from 1 to 40 wt. %, or 5 to 40 wt. %, or 10 to 40 wt. %, or 12 to 40 wt. %, 13 to 40 wt. %, or 15 to 40 wt. %, or greater than 15 to 40 wt. %, or 17 to 40 wt. %, or 20 to 40 wt. %, or 25 to 40 wt. %, or 5 to 35 wt. %, or 10 to 35 wt. %, or 13 to 35 wt. %, or 15 to 35 wt. %, or greater than 15 to 35 wt. %, or 17 to 35 wt. %, or 20 to 35 wt. %, or 5 to 30 wt. %, or 10 to 30 wt. %, or 13 to 30 wt. %, or 15 to 30 wt. %, or greater than 15 to 30 wt. %, or 17 to 30 wt. %, or 5 to 25 wt. %, or 10 to 25 wt. %, or 13 to 25 wt. %, or 15 to 25 wt. %, or greater than 15 to 25 wt. %, or 17 to 25 wt. %, or 5 to 20 wt. %, or 10 to 20 wt. %, or 13 to 20 wt. %, or 15 to 20 wt. %, or greater than 15 to 20 wt. %, or 17 to 20 wt. %, or 5 to 17 wt. %, or 10 to 17 wt. %, or 13 to 17 wt. %, or 15 to 17 wt. %, or greater than 15 to 17 wt. %, or 5 to less than 17 wt. %, or 10 to less than 17 wt. %, or 13 to less than 17 wt. %, or 15 to less than 17 wt. %, all based on the total weight of the flowable melt composition.

In one embodiment or in combination with any other embodiment, the at least one viscosity reducing additive includes or is a food-compliant or FDA approved viscosity reducing additive. In one embodiment or in combination with any other embodiment, the food-compliant or FDA approved viscosity reducing additive includes or is triacetin or PEG MW 300 to 500.

### Biodegradable Polymers

In one embodiment or in combination with any other embodiment, the flowable melt compositions described herein comprise a biodegradable cellulose ester (BCE) component that comprises at least one BCE, which may include one or more of the cellulose esters described herein, and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one embodiment or in combination with any other embodiment, the flowable melt composition comprises two or more biodegradable polymers. In one embodiment or in combination with any other embodiment, the flowable melt composition contains a biodegradable polymer (other than the BCE) in an amount from 0.1 to less than 50 wt. %, or 1 to 40 wt. %, or 1 to 30 wt. %, or 1 to 25 wt. %, or 1 to 20 wt. %, based on the flowable melt composition. In one embodiment or in combination with any other embodiment, the flowable melt composition contains a biodegradable polymer (other than the BCE) in an amount from 0.1 to less than 50 wt. %, or 1 to 40 wt. %, or 1 to 30 wt. %, or 1 to 25 wt. %, or 1 to 20 wt. %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Blowing Agents

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agents function to reduce density of a material by expanding cells formed in the molten formulation at the nucleation sites. The blowing agent may be added to the flowable melt composition in the extruder. It has been surprisingly discovered that the hygroscopic nature of biodegradable particulate natural fillers allows them to absorb moisture and carry the absorbed water into the molten resin mixture where the water can act as a physical blowing agent.

In some embodiments, the BAs comprise endothermic CBAs. In some embodiments, the CBAs are biodegradable. For example, in some embodiments, the CBAs comprise citric acid and/or sodium bicarbonate. In some specific embodiments, the CBAs comprise a combinate of citric acid, sodium bicarbonate, and a carrier. When the CBAs are biodegradable, the carrier may comprise polybutylene succinate (i.e., PBSA or poly(butylene succinate-co-butylene adipate) and/or polycaprolactone (i.e., Caprolactone). In embodiments in which the CBAs are non-biodegradable, the carrier may comprise polystyrene. In other embodiments, the BAs may comprise PBAs, such as water. Regardless, the BAs, i.e., CBAs or PBAs, may be present in the flowable melt composition in amounts from 0.1 to 5.0 wt. %, 0.1 to 4.0 wt. %, from 0.1 to 3.0 wt. %, from 0.1 to 2.0 wt. %, from 0.25 to 2.0 wt. %, from 0.5 to 1.5 wt. %, from 0.75 to 1.25 wt. %, or about 1.0 wt. %. For instance, when the BA is biodegradable CBA, the CBA may be present from 0.1 to 5.0 wt. %. When the BA is a non-biodegradable CBA, the CBA may be present from 0.1 to 2.0 wt. %.

Examples of physical blowing agents include H₂O, N₂, CO₂, alkanes, alkenes, ethers, ketones, argon, helium, air or mixtures. In addition, it has been surprisingly discovered that the hygroscopic nature of biodegradable particulate natural fillers allows them to absorb moisture and carry the absorbed water into the molten resin mixture where the water can act as a physical blowing agent. Hygroscopic biodegradable natural fillers can be formulated into a composition and allowed to absorb moisture prior to the injection molding process, where the water then is released to act as a physical blowing agent. Beneficially, the water may also be used as a plasticizer for the cellulose ester resin. Furthermore, in some embodiments, physical blowing agents may include hydrocarbons, such as pentane/isopentane or butane/isobutane. Other hydrocarbons may include propane, ethane, methane, hexane, cyclohexane, cyclopentane, cyclobutene, or the like.

Chemical blowing agents are materials that degrade or react to produce a gas (e.g., CO₂ or N₂). Chemical blowing agents may be endothermic or exothermic. Chemical blowing agents typically degrade at a certain temperature to decompose and release gas. Examples of chemical blowing agents include azodicarbonamide, acids (e.g., citric acid), and carbonates, such as sodium bicarbonate, sodium carbonate, ammonium bicarbonate, ammonium carbonate, zinc carbonate, and the like and combinations thereof.

In one embodiment or in combination with any of the embodiments mentioned herein, the blowing agent is present at from 0.3 to 1.5 wt. %, or 0.3 to 2.0 wt. %, or 0.3 to 2.5 wt. %, or 0.3 to 3.0 wt. %, or 0.3 to 3.5 wt. %, or 0.3 to 4.0 wt. %, or 0.3 to 8%, or 1.3 to 1.5 wt. %, or 1.3 to 2.0 wt. %, or 1.3 to 2.5 wt. %, or 1.3 to 3.0 wt. %, or 1.3 to 3.5 wt. %, or 1.3 to 4.0 wt. %, or 1.3 to 4.5 wt. %, or 1.3 to 5.0 wt. %, or 1.3 to 5.5 wt. %, or 1.5 to 3.0 wt. %, or 1.5 to 4.0 wt. %, or 1.5 to 5.0 wt. %, or 1.5 to 6.0 wt. %, or 2.0 to 3.0 wt. %, or 2.0 to 4.0 wt. %, or 2.0 to 5.0 wt. %, or 2.0 to 6.0 wt. %, or 2.5 to 3.0 wt. %, or 2.5 to 4.0 wt. %, or 2.5 to 5.0 wt. %, or 2.5 to 6.0 wt. %, or 3.0 to 4.0 wt. %, or 3.0 to 5.0 wt. %, or 3.0 to 6.0 wt. %, or 0.0 to 9.0 wt. %, or 0.5 to 9.0 wt. %, or 1.0 to 9.0 wt. %, or 1.5 to 9.0 wt. %, or 2.0 to 9.0 wt. %, or 2.5 to 9.0 wt. %, or 3.0 to 9.0 wt. %, or 3.5 to 9.0 wt. %, or 4.0 to 9.0 wt. %, or 4.5 to 9.0 wt. %, or 5.0 to 9.0 wt. %, or 5.5 to 9.0 wt. %, or 6.0 to 9.0 wt. %, or 6.5 to 9.0 wt. %, or 7.0 to 9.0 wt. %, or 7.5 to 9.0 wt. %, or 8.0 to 9.0 wt. %, or 8.5 to 9.0 wt. %, all based on the total weight of the flowable melt composition. In some embodiments, the blowing agents used herein may comprise a combination or mixture of two or more different types of blowing agents, such as two or more chemical blowing agents, two or more physical blowing agents, and/or a combination of chemical and physical blowing agents. Regardless, in some embodiments, the blowing agents used may be biodegradable, such as the biodegradable chemical blowing agents, citric acid and/or sodium bicarbonate. In some embodiments, the biodegradable chemical blowing agents, citric acid and/or sodium bicarbonate, may be dispersed in a biodegradable carrier, such as polybutylene succinate, polycaprolactone, or combinations thereof.

### Alkaline Filler

The alkaline filler suitable for the invention is at least one selected from the group consisting of metal oxides, metal hydroxides, metal carbonates and mixtures thereof. Blends of alkaline fillers can be used in the flowable melt composition. In one embodiment or in combination with any other embodiment, the alkaline filler is at least one selected from the group consisting of alkaline-earth metal oxides, alkaline-earth metal hydroxides and alkaline-earth carbonates.

The alkaline fillers have specific physical properties. To be suitable in the application, the water-solubility of the alkaline filler at 20-25 °C is only useful within a certain range. If water solubility is too high, then moisture in the melt-processed article can pre-maturely initiate the chemistry of disintegration. If the water solubility is too low, then basic ions (OH⁻¹ or CO₃⁻²) cannot be released from the filler. Furthermore, the pH of a 1 wt. % solution or suspension of the alkaline filler should be pH 8 or greater, which is related to water solubility. If the pH is not 8 or greater, the conditions are not suitable to promote the chemistry of disintegration. In one embodiment or in combination with any other embodiment, the pH of a 1 wt. % solution or suspension of the alkaline filler is pH 8.5 or greater. In one embodiment or in combination with any other embodiment, the pH of a 1 wt. % solution or suspension of the alkaline filler can range from about 8 to about 12, about 8 to about 11.5, about 8 to about 11, about 8 to about 10.5, about 8 to about 10; 8.5 to about 12, about 8.5 to about 11.5, about 8.5 to about 11, about 8.5 to about 10.5, about 8.5 to about 10, about 9 to about 12, about 9 to about 11.5, about 9 to about 11, and about 9 to about 10.5. Not all metal oxides, hydroxides & carbonates are suitable in the invention. For example, aluminum oxide (Al2O3) and titanium dioxide (TiO2) are insoluble in water and do not react with water to form the corresponding hydroxide to change the pH of the water.

“Alkaline efficiency” is defined as the moles of base divided by the kilograms of alkaline filer. Alkaline efficiency of an alkaline filler also dictates its ability to promote disintegration via chemical action. Alkaline efficiency is the moles of basic ion associated with a specific mass of the filler, in the presence of water. For example, CaO and MgO react with water, and two moles of hydroxide ion (OH-1) are formed. An alkaline filler with a higher alkaline efficiency may promote the chemistry underlying disintegration at lower filler loadings on a wt. % basis in the formulation. A stoichiometric amount of an alkaline catalyst is required for the base-catalyzed hydrolysis of an ester, as the resulting acid formed will neutralize the base catalyst and deactivate it.

To be suitable in the application, the water-solubility of the alkaline filler at 20-25 °C should be greater than 1 ppm but less than 1,000 ppm. In other embodiments of the invention, the water-solubility of the alkaline filler at 20-25 °C is between about 2 ppm to about 1,000 ppm, about 2 ppm to about 950 ppm, about 2 ppm to about 900 ppm, about 2 ppm to about 850 ppm, about 2 ppm to about 800 ppm, about 2 ppm to about 750 ppm, about 2 ppm to about 700 ppm, about 2 ppm to about 650 ppm, about 2 ppm to about 600 ppm, about 2 ppm to about 550 ppm, about 2 ppm to about 500 ppm, about 2 ppm to about 450 ppm, about 2 ppm to about 400 ppm, about 2 ppm to about 350 ppm, about 2 ppm to about 300 ppm, 3 ppm to about 1,000 ppm, about 3 ppm to about 950 ppm, about 3 ppm to about 900 ppm, about 3 ppm to about 850 ppm, about 3 ppm to about 800 ppm, about 3 ppm to about 750 ppm, about 3 ppm to about 700 ppm, about 3 ppm to about 650 ppm, about 3 ppm to about 600 ppm, about 3 ppm to about 550 ppm, about 3 ppm to about 500 ppm, about 3 ppm to about 450 ppm, about 3 ppm to about 400 ppm, about 3 ppm to about 350 ppm, about 3 ppm to about 300 ppm, 4 ppm to about 1,000 ppm, about 4 ppm to about 950 ppm, about 4 ppm to about 900 ppm, about 4 ppm to about 850 ppm, about 4 ppm to about 800 ppm, about 4 ppm to about 750 ppm, about 4 ppm to about 700 ppm, about 4 ppm to about 650 ppm, about 4 ppm to about 600 ppm, about 4 ppm to about 550 ppm, about 4 ppm to about 500 ppm, about 4 ppm to about 450 ppm, about 4 ppm to about 400 ppm, about 4 ppm to about 350 ppm, about 4 ppm to about 300 ppm, 5 ppm to about 1,000 ppm, about 5 ppm to about 950 ppm, about 5 ppm to about 900 ppm, about 5 ppm to about 850 ppm, about 5 ppm to about 800 ppm, about 5 ppm to about 750 ppm, about 5 ppm to about 700 ppm, about 5 ppm to about 650 ppm, about 5 ppm to about 600 ppm, about 5 ppm to about 550 ppm, about 5 ppm to about 500 ppm, about 5 ppm to about 450 ppm, about 5 ppm to about 400 ppm, about 5 ppm to about 350 ppm, about and 5 ppm to about 300 ppm.

In one embodiment or in combination with any other embodiment, the pH of a 1 wt. % suspension of the alkaline filler should be 8 or greater, and the alkaline efficiency should be at least 5. In one embodiment or in combination with any other embodiment, the alkaline efficiency is at least 6, at least 7, at least 8, at least 9, or at least 10. The table below shows comparative properties of a selection of alkaline fillers, only some of which meet all the criteria for the invention. Examples of alkaline fillers that meet the criteria include calcium carbonate (CaCO3), magnesium oxide (MgO), magnesium hydroxide (Mg(OH)₂), magnesium carbonate (MgCO3), and barium carbonate (BaCO3). Alkaline fillers that are effective and readily available are calcium carbonate (CaCO3), magnesium oxide (MgO), magnesium hydroxide (Mg(OH)₂), and magnesium carbonate (MgCO3). In addition, these alkaline fillers are especially suitable for food contact applications.

In some embodiments herein, the alkaline filler is present at from 1 to 25 wt. % of the flowable melt composition. All individual values and subranges are included and disclosed herein. For example, in some embodiments, the alkaline filler is present at a lower limit of 1, 2, 5, 7, 10, 12, or 15 wt. % to an upper limit of 25, 23, 21, or 20 wt. % of the flowable melt composition.

In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 1 to 25 weight % and the at least one of the following of magnesium oxide, magnesium hydroxide, or magnesium carbonate is present at from 1 to 20 weight % based on the total weight of the flowable melt composition. In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 5 to 15 weight % and the at least one of the following of magnesium oxide, magnesium hydroxide, or magnesium carbonate is present at from 1 to 20 weight % based on the total weight of the flowable melt composition. In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 5 to 10 weight % and the at least one of the following of magnesium oxide, magnesium hydroxide, or magnesium carbonate is present at from 1 to 20 weight % based on the total weight of the flowable melt composition.

The alkaline filler may be hydrated. A blend of alkaline fillers is also an option for creating alkaline conditions to promote disintegration. An alkaline filler, hydrate or blend may be a natural or synthetic blend, compound or mineral. For example, magnesium carbonate can be mined as the mineral magnesite or prepared in the laboratory by reacting a soluble magnesium salt with sodium bicarbonate. Examples of hydrates and blends as minerals include basic magnesium carbonate (BMC, typically hydrated with 3 to 5 water molecules), artinite (4MgCO3·Mg(OH)2·3H2O), hydromagnesite (Mg5(CO3)4(OH)2·4H2O), dypingite (4MgCO3·Mg(OH)2·5H2O) and dolomite (CaCO3·MgCO3). If a soluble magnesium salt (e.g. magnesium chloride or sulfate) is treated with sodium carbonate or sodium bicarbonate, depending on the reaction temperature and CO2 partial pressure, the resulting precipitate may include a hydrated complex of magnesium carbonate and/or magnesium hydroxide, such as [MgCO3·3H2O] or [4MgCO3·Mg(OH)2·4H2O]. A blend may also be made by combining MgO, Mg(OH)2 and/or an anhydrous or hydrated form of MgCO3 with each other, or with another mineral in the same water solubility range (e.g. CaCO3 or BaCO3).

### Neutralizing Agent

The melt processable flowable melt composition also contains at least one neutralizing agent. To manage alkalinity or free alkali as a source of color, a neutralizing agent is also required in the formulation. The neutralizing agent is a carboxylic acid with a first pKa in the range of about 2 to about 7 or about 2 to about 6. Examples of neutralizing agents include, but are not limited to, citric acid, malic acid, succinic acid, adipic acid, fumaric acid, formic acid, lactic acid, maleic acid, tartaric acid, malonic acid, glutamic acid, glutaric acid, gluconic acid, isophthalic acid, terephthalic acid, glycolic acid, itaconic acid, ferulic acid, mandelic acid, aconitic acid, benzoic acid, aspartic acid, and vanillic acid.

In one embodiment or in combination with any other embodiment, the neutralizing agents are selected from the group consisting of citric acid, malic acid, succinic acid, adipic acid, and fumaric acid, especially for the use of flowable melt compositions in food contact applications. In one embodiment or in combination with any other embodiment, the neutralizing agents are selected from the group consisting of citric acid, adipic acid, or fumaric acid.

The minimum amount of the neutralizing agent is that which is sufficient to neutralize the free alkali in the flowable melt composition. However, an excess amount can be added. In one embodiment or in combination with any other embodiment, about 0.5 wt. % to about 5 wt. % of the neutralizing agent is added based on the weight of the flowable melt composition. In one embodiment or in combination with any other embodiment, the neutralizing agent is present at from about 0.5 wt. % to about 5 wt. %, or about 0.5 wt. % to about 4.5 wt. %, or about 0.5 wt. % to about 4 wt. %, or about 0.5 wt. % to about 3.5 wt. %, or about 0.5 wt. % to about 3 wt. %, or about 0.5 wt. % to about 2.5 wt. %, or about 0.5 wt. % to about 2 wt. %, or about 0.5 wt. % to about 1 wt. %, or about 1.5 wt. % to about 5 wt. %, or about 1.5 wt. % to about 4.5 wt. %, or 1 wt. % to about 5 wt. %, or about 1 wt. % to about 4.5 wt. %, or about 1 wt. % to about 4 wt. %, or about 1 wt. % to about 3.5 wt. %, or about 1 wt. % to about 3 wt. %, or about 1 wt. % to about 2.5 wt. %, or about 1.5 wt. % to about 5 wt. %, or about 1.5 wt. % to about 4.5 wt. %, or about 1.5 wt. % to about 4 wt. %, or about 1.5 wt. % to about 3.5 wt. %, or about 1.5 wt. % to about 3 wt. %, or about 1.5 wt. % to about 2.5 wt. %, or about 2 wt. % to about 5 wt. %, or about 2 wt. % to about 4.5 wt. %, or about 2 wt. % to about 4 wt. %, or about 2 wt. % to about 3.5 wt. %, or about 2 wt. % to about 3 wt. % of the neutralizing agent is added based on the weight of the flowable melt composition

### Articles

Rigid articles may be formed from the flowable melt composition via injection molding. Such flowable melt composition may beneficially include one or more chemical blowing agents, which as discussed below, improve the flowability of the resin during injection molding. Exemplary articles include straws, cups, lids, trays, bowls, pots, cutlery (e.g., forks, knives, spoons, etc.), and the like. In some embodiments, the articles may be single-use items, such as cutlery (e.g., forks, knives, spoons, etc.). Alternatively, the articles may be multiple-use items, such as cups, bowls, pots, etc. The articles may have one or more particularly advantageous properties. For example, the articles may be biodegradable, compostable, recyclable and/or the articles may have superior mechanical properties (e.g., strength, density, cell size, absorption, etc.).

In one embodiment or in combination with any of the embodiments mentioned herein, the rigid articles may have a density greater than 0.90 g/cm³, greater than 1.0 g/cm³, greater than 1.10 g/cm³, greater than 1.20 g/cm³, greater than 1.30 g/cm³, greater than 1.40 g/cm³, greater than 1.50 g/cm³, and/or no more than 1.60 g/cm³, no more than 1.50 g/cm³, no more than 1.40 g/cm³, no more than 1.30 g/cm³, no more than 1.20 g/cm³, no more than 1.10 g/cm³, or no more than 1.0 g/cm³. In some embodiments, the rigid articles will have a density from 0.90 g/cm³ to 1.60 g/cm³, from 1.00 g/cm³ to 1.60 g/cm³, from 1.10 g/cm³ to 1.60 g/cm³, from 1.20 g/cm³ to 1.60 g/cm³, from 1.30 g/cm³ to 1.60 g/cm³, from 1.40 g/cm³ to 1.60 g/cm³, from 1.50 g/cm³ to 1.60 g/cm³, from 0.90 g/cm³ to 1.50 g/cm³, from 1.00 g/cm³ to 1.50 g/cm³, from 1.10 g/cm³ to 1.50 g/cm³, from 1.20 g/cm³ to 1.50 g/cm³, from 1.30 g/cm³ to 1.50 g/cm³, from 1.40 g/cm³ to 1.50 g/cm³, from 0.90 g/cm³ to 1.40 g/cm³, from 1.00 g/cm³ to 1.40 g/cm³, from 1.10 g/cm³ to 1.40 g/cm³, from 1.20 g/cm³ to 1.40 g/cm³, from 1.30 g/cm³ to 1.40 g/cm³, from 0.90 g/cm³ to 1.30 g/cm³, from 1.00 g/cm³ to 1.30 g/cm³, from 1.10 g/cm³ to 1.30 g/cm³, from 1.20 g/cm³ to 1.30 g/cm³, from 0.90 g/cm³ to 1.20 g/cm³, from 1.00 g/cm³ to 1.20 g/cm³, from 1.10 g/cm³ to 1.20 g/cm³, from 0.90 g/cm³ to 1.10 g/cm³, from 1.00 g/cm³ to 1.10 g/cm³, and/or from 0.90 g/cm³ to 1.00 g/cm³.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

To be considered “compostable,” a material must meet the following four criteria: (1) the material should pass biodegradation requirement in a test under controlled composting conditions at elevated temperature (58 °C) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth.

As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any of the embodiments mentioned herein, the biodegradable rigid article is industrial compostable or home compostable. In one subclass of this class, the rigid article is industrial compostable. In one sub-subclass of this subclass, the rigid article has a thickness that is less than 6 mm. In one sub-subclass of this subclass, the rigid article has a thickness that is less than 3 mm. In one sub-subclass of this subclass, the rigid article has a thickness that is less than 1.1 mm. In one subclass of this class, the rigid article is home compostable. In one sub-subclass of this subclass, the rigid article has a thickness that is less than 6 mm. In one sub-subclass of this subclass, the rigid article has a thickness that is less than 3 mm. In one sub-subclass of this subclass, the rigid article has a thickness that is less than 1.1 mm. In one sub-subclass of this subclass, the rigid article has a thickness that is less than 0.8 mm. In one sub-subclass of this subclass, the rigid article has a thickness that is less than 0.6 mm. In one sub-subclass of this subclass, the rigid article has a thickness that is less than 0.4 mm.

In one embodiment or in combination with any of the embodiments mentioned herein, the thickness of the rigid article is from 1 to 10 mm, from 1 to 8 mm, from 2 to 8 mm, from 3 to 7 mm, from 4 to 6 mm, about 4 mm, about 5 mm, about 6 mm, about 7 mm, or about 8 mm. However, it should be noted that the rigid article may have other, larger sizes. For example, in some embodiments, the rigid article may have a thickness from 0.5 to 24 inches, from 1 to 15 inches, or 3 to 12 inches.

In one embodiment or in combination with any of the embodiments mentioned herein, the rigid article exhibits greater than 90% disintegration after 12 weeks according to the disintegration test protocol for films, as described in the specification.

The compositions used to prepare the biodegradable rigid articles can comprise other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, UV absorbers, and combinations thereof. Each additional additive may be present in the cellulose ester-based material in an amount less than 10 wt. %, less than 5 wt. % less than 4 wt. %, less than 3 wt. %, less than 2 wt. %, or less than 1.0 wt. %. It should be noted that the same type of compounds or materials can be identified for or included in multiple categories of components in the flowable melt compositions. For example, polyethylene glycol (PEG) could function as a viscosity reducing additive or as an additive that does not function as a viscosity reducing additive, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment mentioned herein, the rigid composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the rigid composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide. In one subclass of this class, the pigment is a biodegradable particulate natural filler.

### EXAMPLES

TABLE 1
Test Methods

| | |
|---|---|
| Metals Content | The metals content may be carried out by Inductively Coupled |
| | Plasma Optical Emission Spectrometry (ICP-OES) where an ester |
| | sample is prepared by digesting 1 g of ester in 10 mL of trace- |
| | metal grade nitric acid (HNO₃). Digestion is carried out for 1 hour. |
| | The digested sample is then treated by adding 1 mL internal |
| | standard and diluting the mixture to 100 mL total with high purity |
| | water. The Internal Standard Solution contains 10,000 mg/mL |
| | (ppm) Be, Sc, and Y (CAS RN 7440-65-5) in 2% HNO₃. The |
| | sample is then pumped into an ICP-OES, which is generating an |
| | argon plasma. The plasma atomizes and excites elements present |
| | in the sample. The resulting emission from the excited state is |
| | detected and used to quantify the concentration of those elements |
| | in solution based on comparison of the response to that of |
| | standards of known concentration. |
| Spiral Flow (inches) | A reciprocating screw injection molding machine having 55 tons |
| | of clamping force with a screw diameter of 1.1 inch is equipped |
| | with a water-cooled, cold runner mold with a spiral-shaped cavity |
| | having dimensions of 0.50″ wide, 0.030″ deep, 60.00″ in length. |
| | The cavity is fed via a 3.5″ long cold sprue with a nominal 0.400″ |
| | diameter and 3-degree taper, followed by a 1.0″ long cold runner |
| | with 0.30″ nominal diameter, followed by a rectangular gate 0.25″ |
| | wide, 0.030″ thick, 0.10″ long. Variables controlled for the range |
| | of experimentation included resin drying, injection unit barrel |
| | temperature, mold temperature, initial injection speed, injection |
| | pressure limit, screw rotation speed and back pressure on screw |
| | recovery, injection time, and cycle time. |
| | For each combination of variables, responses included actual melt |
| | temperature and distance of melt travel in the spiral-shaped cavity, |
| | excluding the runner and gate. The injection process is allowed to |
| | stabilize at each set of conditions-typically 50 shots-and then |
| | 10 molded specimens are collected for an average reported flow |
| | length. |
| | All materials are molded using pressure control, with barrel |
| | temperatures of 440, 460 and 480 F, mold temperature of 158 |
| | °F. (70 °C), initial injection speed of 1 in/s, injection unit |
| | pressure limit of 2000 psi, injection time of 5 s, cycle time of 32 |
| | s, maximum cushion of 0.2″, screw recovery rotation speed of 125 |
| | rpm, and screw recovery back pressure of 100 psi. |
| Density Reduction | The weight of the article is measured in grams before and after |
| | in-mold foaming using physical blowing agents and chemical |
| | blowing agents. The % difference is used to estimate the density |
| | reduction as density is directly proportional to weight for a |
| | constant volume of parts molded. |
| Heat Deflection Temperature | ASTM D648 |
| (HDT) (°C) | |
| % Water Absorption | ASTM D570 |
| Flexural Modulus (MPa) | ASTM D790 |
| Notched IZOD (J/m) | ASTM D256 |
| Un-Notched Izod (J/m) | ASTM D4812 |

TABLE 2
Materials

| | | |
|---|---|---|
| Cellulose Diacetate | A cellulose diacetate having a | Available from Eastman Chemical |
| | degree of substitution of acetyl | Company (Kingsport, TN) |
| | substituents (DSAC) per | |
| | anhydroglucose unit (AGU) of 2.4- | |
| | 2.6; a metals-to-sulfur molar ratio | |
| | (M/S) of 1.35 to 5.0; and a number | |
| | average molecular weight (Mn) of | |
| | 80,000-120,000. | |
| PEG400 | Polyethylene glycol having a MW | Available from Univar Solutions |
| | of 400 g/mol; viscosity reducing | (Downers Grove, IL) |
| | additive | |
| Chemical Blowing Agent 1 | Foamazol ™ 73, a chemical | Available from Bergen |
| (CBA1) | Endothermic Decomposition | International (East Rutherford, NJ) |
| | blowing agent. | |
| Chemical Blowing Agent 2 | TecoCell ™ GT, a chemical | Available from Trexel, Inc. |
| (CBA2) | Endothermic Decomposition | (Wilmington, MA) |
| | blowing agent. | |
| Calcium Carbonate | Alkaline Filler | Available from Omya AG |
| | | (Oftringen, Switzerland) |
| Magnesium Oxide | Alkaline Filler | Available from Martin Marietta |
| | | Magnesia Specialties, LLC |
| | | (Baltimore, MD) |
| Citric Acid | Neutralizing Agent | Available from Sigma-Aldrich |
| | | (St. Louis, MO). |

The components indicated in Tables 2 & 3 (w/o blowing agent) are blended and compounded together according to the weight percentages shown in Table 3, to form pellets. The ratio of calcium carbonate to magnesium in the total amount of alkaline filler is 3:1. The pellets are subsequently used in an injection molding machine with blowing agents to form injection molded articles. A thick flexible bar mold is used having the following dimensions: a two-cavity flex bar mold that results in flex bars that are 0.125 inch thick, 0.50 inch wide, and 5.0 inch long. A cutlery mold is formed having the following characteristics: a two-cavity knife and fork mold that results in knife and forks that are ⅜ inch thick, 0.5 inch wide in the handle, and 6.5 inch long. An injection molded plaque is formed having the following characteristics: a one-cavity plaque mold that results in plaques that are 0.060 inch thick, 5.0 inch wide, and 5.0 inch long. Properties of the molds and plaque are show in Tables 3-7.

TABLE 3
Compositions

| | | | | | Inv. 4 & | | |
|---|---|---|---|---|---|---|---|
| | Comp. | Inv. 1 | Inv. 2 | Inv. 3 | Inv. 6 | Inv. 5 | Inv. 7 |
| | A & B | CDA + | CDA + | CDA + | CDA + | CDA + | CDA + |
| | CDA | 2% CBA1 | 2% CBA2 | 4% CBA2 | 0.5% N2 | 0.75% N2 | 0.35% N2 |
| Density reduction | Base | — | 4.0 | 5.0 | 15.0 | 14.0 | 14.0 |
| Cellulose Diacetate | 65.9 | 64.6 | 64.6 | 63.4 | 65.6 | 65.4 | 65.7 |
| (CDA) | | | | | | | |
| Viscosity Reducing | 12.0 | 11.8 | 11.8 | 11.5 | 11.9 | 11.9 | 11.9 |
| Additive | | | | | | | |
| Chemical Blowing | — | 2.0 | — | — | — | — | — |
| Agent 1 | | | | | | | |
| Chemical Blowing | — | — | 2.0 | 3.9 | — | — | — |
| Agent 2 | | | | | | | |
| Physical Blowing | — | — | — | — | 0.5 | 0.7 | 0.4 |
| Agent (N₂) | | | | | | | |
| Total Alkaline Filler | 20.0 | 19.5 | 19.5 | 19.2 | 19.9 | 19.9 | 19.9 |
| Neutralizing Agent | 2.0 | 2.0 | 2.0 | 1.9 | 2.0 | 2.0 | 2.0 |
| Water | 0.1 | 0.1 | 0.1 | 0.1 | 0.1 | 0.1 | 0.1 |

As shown in Table 3, the inventive compositions show a density reduction of between 4 wt. % and 15.0 wt. % as compared to the comparative compositions.

TABLE 4
Spiral Flow at Various Temperatures

| | Temperature °F | | |
|---|---|---|---|
| | 440 | 460 | 480 |
| Comp. A | 3 | 4.25 | 5.25 |
| Inv. 1 | 3.2 | 4.5 | 6.6 |
| Increased flow (%) | 7% | 6% | 26% |

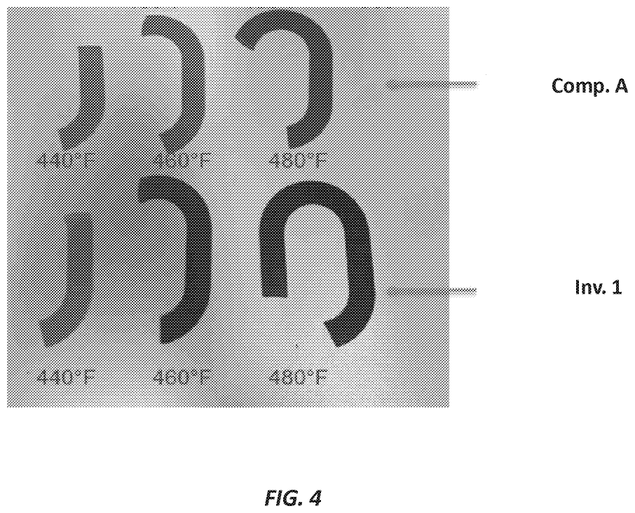

As shown in Table 4, the spiral flow length is measured at different temperatures. The length of the flow is a measure of flowability/viscosity. The inventive composition achieves about the same flow length of 5.25 as the comparative composition, but at about 467 °F, which is a lower temperature. Improved flow can result in faster cycle times on injection molding machines, and/or the ability to run at reduced temperatures. As shown in FIG. 4, materials molded into spiral flow mold have different flow length. Increasing barrel temperatures will lead to an increase in flow as a result of shear thinning behavior (reduced viscosity) of polymer. Also adding CBA1 will result in higher flow length as a result of a plasticizing effect of CBA.

TABLE 5
Thick Flexible Bar Mold

| | Comp. A | | |
|---|---|---|---|
| | Wt. % | Inv. 2 | Inv. 3 |
| Formerly | CDA | CDA + 2% | CDA + 4% |
| | | CBA2 | CBA2 |
| Inj. Mold. Temp (°F) | 460 | 460 | 460 |
| Part Weight (g) | 7.46 | 7.16 | 7.09 |
| % Part Weight Reduction | — | 4 | 5 |
| Peak Inj. Mold. Pressure | 14,500 | 13,180 | 12,300 |
| (psi) | | | |
| % Inj. Mold Pressure | — | 9 | 15 |
| Reduction | | | |
| Peak VPT Pressure (psi) | 9,250 | 720 | 520 |
| % VPT Pressure | — | 92 | 94 |
| Reduction | | | |
| Cycle Time (sec) | 26.8 | 20.8 | 20.8 |
| % Cycle Time Reduction | — | 22 | 22 |
| HDT (0.455 MPa) (°C) | 78.5 | 78.1 | 78.1 |
| % Water Abs | 14.88 | 18.6 | 17.22 |
| Flexural Modulus (MPa) | 3259.6 | 3136.2 | 3056.5 |
| Notched IZOD (J/m) | 44.72 | 40.44 | 40.15 |
| Un-Notched Izod (J/m) | 1303 | 546.78 | 385.53 |

As shown in Table 5, the inventive thick flexible bar molds show a reduction in density, injection molding pressure, VPT pressure, and cycle time when compared to the comparative thick flexible bar mold. Also, the

TABLE 6
Cutlery Mold

| | | % Inj. Mold | | |
|---|---|---|---|---|
| | Peak Inj. Mold | Pressure | Cycle Time | % Cycle Time |
| | Pressure (psi) | Reduction | (sec) | Reduction |
| Comp A | 2504 | — | 19.7 | — |
| Inv 2 | 2500 | 0 | 13.7 | 30 |

As shown in Table 6, the inventive cutlery mold shows a reduction in injection molding pressure and cycle time when compared to the comparative cutlery mold.

TABLE 7
Injection Molded Plaque

| | | | | Inj. | Peak Inj. | % Inj. |
|---|---|---|---|---|---|---|
| | N₂ | Part | % Part | Mold. | Mold. | Mold |
| | level | Weight | Weight | Temp. | Pressure | Pressure |
| | (%) | (g) | Reduction | (F) | (psi) | Reduction |
| Comp. A | 0 | 34.5 | — | 475 | 20800 | — |
| Inv. 4 | 0.5 | 33.3 | 9.85% | 475 | 16000 | 23% |
| Comp. B | 0 | 36.94 | — | 490 | 15300 | — |
| Inv. 5 | 0.75 | 31.95 | 13.51% | 490 | 13200 | 13% |
| Inv. 6 | 0.5 | 31.5 | 14.73% | 490 | 11800 | 22% |
| Inv. 7 | 0.35 | 31.8 | 13.91% | 490 | 12500 | 18% |

As shown in Table 7, the inventive injection molded plaques show a reduction in density and injection molding pressure when compared to the comparative injection molded plaques.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. (canceled)

2. A method of manufacturing an injection molded article, the method comprising:
providing a flowable melt composition comprising a cellulose diacetate, a viscosity reducing additive, and a physical blowing agent;
introducing the flowable melt composition into a mold cavity of an injection molding machine;
molding the flowable melt composition at a pressure P, a temperature T, and a cycle time C in the mold cavity to form the injection molded article having a length L and a density D in the range of 0.9 to 1.6 g/cc, wherein the pressure P is from 10,000 to 40,000 psi, the temperature T is from 400 to 560 degrees Fahrenheit, and the cycle time C is from 8 to 30 seconds;
wherein the method exhibits at least one of the following:
a reduction in pressure P by 5% to 40% when compared to an injection molding pressure P2 required to form an injection molded article using a melt composition having the same formulation as the flowable melt composition but without the physical blowing agent;
a reduction in temperature T by 1% to 15% when compared to an injection molding temperature T2 required to form an injection molded article using a melt composition having the same formulation as the flowable melt composition but without the physical blowing agent;
a reduction in cycle time C by 2% to 30% when compared to an injection molding cycle time C2 required to form an injection molded article using a melt composition having the same formulation as the flowable melt composition but without the physical blowing agent.

3. (canceled)

4. The method of claim 2, wherein the physical blowing agent is selected from the group consisting of hydrocarbons, chlorofluorocarbons, nitrogen, carbon dioxide, alcohols, ketones, methyl esters, and combinations thereof, and is present in an amount of 0.1 to 5.0 wt. % of the flowable melt composition.

5. The method of claim 2, wherein the cellulose diacetate is present in an amount of 50 to 80 wt. % of the flowable melt composition.

6. The method of claim 2, wherein the cellulose diacetate exhibits one or more of the following properties: a degree of substitution of acetyl substituents (DSAC) per anhydroglucose unit (AGU) is 2.2 to 2.8; a metals-to-sulfur molar ratio (M/S) of from 1.35 to 5.0; or a number average molecular weight (Mn) of from 10,000 g/mol to 100,000 g/mol as according to ASTM D6474.

7. The method of claim 2, wherein the viscosity reducing additive is present in an amount of 2 to 40 wt. % of the flowable melt composition.

8. The method of claim 2, wherein the viscosity reducing additive is selected from the group consisting of glycerol triacetate (triacetin), glycerol diacetate, dibutyl terephthalate, dimethyl phthalate, diethyl phthalate, polyethylene glycol having a molecular weight of 200-600 g/mol, triethylene glycol dipropionate, 1,2-epoxypropylphenyl ethylene glycol, 1,2-epoxypropyl(m-cresyl)ethylene glycol, 1,2-epoxypropyl(o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, tripropionin, poloxamer copolymers, polyethylene glycol succinate, diisobutyl adipate, polyvinyl pyrollidone, and glycol tribenzoate, triethyl citrate, acetyl triethyl citrate, polyethylene glycol, poly (alkyl succinates) such as poly (butyl succinate), polyethersulfones, adipate based viscosity reducing additives, soybean oil epoxides, sucrose-based viscosity reducing additives, dibutyl sebacate, tributyrin, tripropionin, sucrose acetate isobutyrate, the Resolflex™ series of viscosity reducing additives, triphenyl phosphate, glycolates, methoxy polyethylene glycol, 2,2,4-trimethylpentane-1,3-diyl bis(2-methylpropanoate), and polycaprolactones, and combinations of two or more thereof.

9. The method of claim 2, wherein the flowable melt composition is biodegradable and/or compostable.

10. The method of claim 2, wherein the flowable melt composition further comprises an alkaline filler present in an amount of 1 to 25 wt. % of the flowable melt composition and/or a neutralizing agent, suitable for neutralizing the free alkali in the flowable melt composition, present in an amount of 0.1 to 5 wt. % of the flowable melt composition.

11. (canceled)

12. (canceled)

13. (canceled)

14. (canceled)

15. (canceled)

16. (canceled)

17. (canceled)

18. (canceled)

19. (canceled)

20. (canceled)

21. An injection molded article, the article being formed according to the method of claim 2.

22. The injection molded article of claim 21, wherein the article is a single-use or multi-use cutlery article, a utensil, a cup, a plate, a bowl, or a tray.
